(19) United States
(12) Patent Application Publication
(10) Pub. No.: US 2026/0133824 A1
(43) Pub. Date: May 14, 2026

(54) Layered Workflows for Computing Systems

(71) Applicant: ServiceNow, Inc., Santa Clara, CA (US)

(72) Inventors: Jacob Burman, Carlsbad, CA (US); Brian Bimschleger, Santa Clara, CA (US); Jason Lefever, Hopedale, MA (US); Alberto Alvarado Jimenez, Santee, CA (US); Harry Thomas Nelson, San Diego, CA (US); Yaron Guez, San Diego, CA (US); Jan Ove Kristian Olsson, Santa Clara, CA (US)

(21) Appl. No.: 18/946,395

(22) Filed: Nov. 13, 2024

(51) Int. Cl. G06F 9/48

(52) U.S. Cl. CPC G06F 9/4881

(57) ABSTRACT

An example implementation may include: obtaining a child workflow derived from a parent workflow, wherein the parent workflow is specified to include states and transitions therebetween; determining a modified state or transition of the child workflow; obtaining a starting rule of the child workflow that specifies a condition under which execution of the child workflow begins; and storing, in a memory, a representation of the child workflow as a reference to the parent workflow and differences between the child workflow and the parent workflow, wherein the differences include the starting rule and the modified state or transition.

### BACKGROUND

Computing platforms can be used to facilitate workflows—automated or semi-automated multi-step processes that occur between any combination of computing elements, applications, and/or individuals. These workflows can be complex, involving numerous states and transitions therebetween that may be followed based on conditional processing. As the relevance of workflows grows, so do the number of workflows supported and their importance to the proper operation of software applications and services. Thus, deploying workflows that duplicate some or all of the functionality of other workflows can waste computing resources (e.g., processing, memory, and/or network capacity).

### SUMMARY

Various implementations disclosed herein include techniques for designing, developing, and deploying layered workflows that support hierarchical variations of their states, transitions, and conditional processing. A layered workflow can be specified as a filter applied atop a parent workflow to derive a child workflow. The child workflow overrides the processing of one or more states and transitions, adds new states to the parent workflow, and/or removes states from the parent workflow. Changes made to a parent workflow (e.g., in the processing of a state or the addition or removal of a state) are automatically applied to all of its child workflows, but changes to a child workflow are not automatically applied its parent workflow. Thus, child workflows generally inherit the properties of their parent workflows, but parent workflows do not inherit the properties of their child workflows.

In previous scenarios, supporting variants of a workflow would require separate workflows to be developed, tested, and deployed, and then updated as needed. However, maintaining such variants quickly becomes complicated, as any changes to the basic workflow structure (i.e., what would be the parent workflow) may need to be propagated to each of the workflow variants. Further, multiple workflows take up significantly more memory than a single workflow. Alternatively, a single workflow with conditional states, transitions, and processing could be developed to handle all variant scenarios. However, there are a number of issues with a single workflow such as difficulty in enacting changes, inability to support variants, difficultly with navigation, etc.

Layered workflows address these disadvantages. Multiple child workflows can be derived from a single parent workflow. Each child workflow need only be specified in terms of its differences from the parent workflow, thus saving memory as the whole workflow is not reproduced for each child workflow. Further, permission controls can be put in place so that the impact of any change to a child workflow is limited just to that child workflow and not any other child workflow.

Accordingly, a first example embodiment may involve: obtaining a child workflow derived from a parent workflow, wherein the parent workflow is specified to include states and transitions therebetween; determining a modified state or transition of the child workflow; obtaining a starting rule of the child workflow that specifies a condition under which execution of the child workflow begins; and storing, in a memory, a representation of the child workflow as a reference to the parent workflow and differences between the child workflow and the parent workflow, wherein the differences include the starting rule and the modified state or transition.

A second example embodiment may involve a non-transitory computer-readable medium, having stored thereon program instructions that, upon execution by a computing system, cause the computing system to perform operations in accordance with any of the previous example embodiments.

In a third example embodiment, a computing system may include at least one processor, as well as memory and program instructions. The program instructions may be stored in the memory, and upon execution by the at least one processor, cause the computing system to perform operations in accordance with any of the previous example embodiments.

In a fourth example embodiment, a system may include various means for carrying out each of the operations of any of the previous example embodiments.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts a workflow, in accordance with example embodiments.

FIGS. 7A, 7B, and 7C depict child workflows, in accordance with example embodiments.

FIG. 8 depicts a memory arrangement for storing workflow variants, in accordance with example embodiments.

FIG. 9 depicts a graphical user interface for a base workflow, in accordance with example embodiments.

FIGS. 10A, 10B, and 10C depict graphical user interfaces for child workflow variants, in accordance with example embodiments.

FIGS. 11A and 11B depict visual representations of workflow rewind, in accordance with example embodiments.

FIGS. 12A, 12B, and 12C depict visual representations of workflow inheritance and editing, in accordance with example embodiments

FIG. 13 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of software features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Example Technical Improvements

These embodiments provide a technical solution to a technical problem. One technical problem being solved is efficient storage and modification of multiple variants of a workflow. In practice, this is problematic because workflows are becoming widely deployed and important aspects of numerous computing environments.

In other techniques, workflow variants were implemented either as multiple workflows or a single complicated workflow. However, these techniques do not scale, lack memory efficiency, and cannot easily be modified. For example, multiple variants of a workflow would require separate workflows to be developed, tested, and deployed, and then updated as needed. But doing so quickly becomes complicated, as any changes to the basic workflow structure must be propagated to each of the other workflows. Further, multiple workflows take up significantly more memory than a single workflow. In another example, employing a single workflow with conditional states, transitions, and processing instead of multiple workflows would be very complicated and not robust in the presence of change. Thus, other techniques did little if anything to address workflow efficiency and flexibility.

The embodiments herein overcome these limitations with layered workflows that support hierarchical variations of their states, transitions, and conditional processing. A layered workflow can be specified as a filter applied atop a parent workflow to derive a child workflow. The child workflow overrides the processing of one or more states and transitions, adds new states to the parent workflow, and/or removes states from the parent workflow. In this manner, workflow efficiency and flexibility can be accomplished in a robust fashion. This results in several advantages. Multiple child workflows can be derived from a single parent workflow. Each child workflow need only be specified in terms of its differences from the parent workflow, thus saving memory as the whole workflow is not reproduced for each child workflow. Further, permission controls can be put in place so that the impact of any change to a child workflow is limited just to that child workflow and not any other child workflow.

Other technical improvements may also flow from these embodiments, and other technical problems may be solved. Thus, this statement of technical improvements is not limiting and instead constitutes examples of advantages that can be realized from the embodiments.

### II. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or eXtensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### III. Example Computing Devices and Cloud-Based Computing Environments

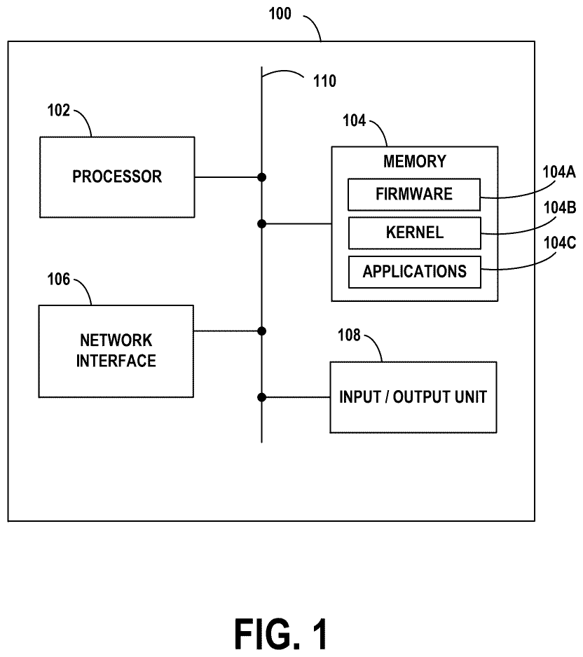

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), a digital signal processor (DSP), a network processor, an encryption processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently used instructions and data.

GPUs, in particular, have grown in importance. They include specialized circuitry designed to perform rapid mathematical calculations for rendering graphics, processing large datasets, and supporting machine learning. A GPU typically consists of hundreds or thousands of small cores that operate simultaneously, facilitating the decomposition of tasks into smaller, more manageable pieces that are processed in parallel. This parallelism allows GPUs to be significantly faster than traditional CPUs for certain types of calculations.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Herein, any non-volatile memory may be referred to as persistent storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Synchronous Digital Hierarchy (SDH), Data Over Cable Service Interface Specification (DOCSIS), or other technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

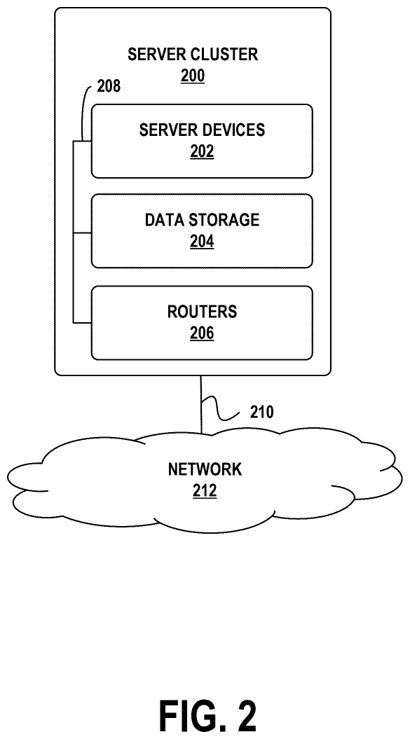

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. Example Remote Network Management Architecture

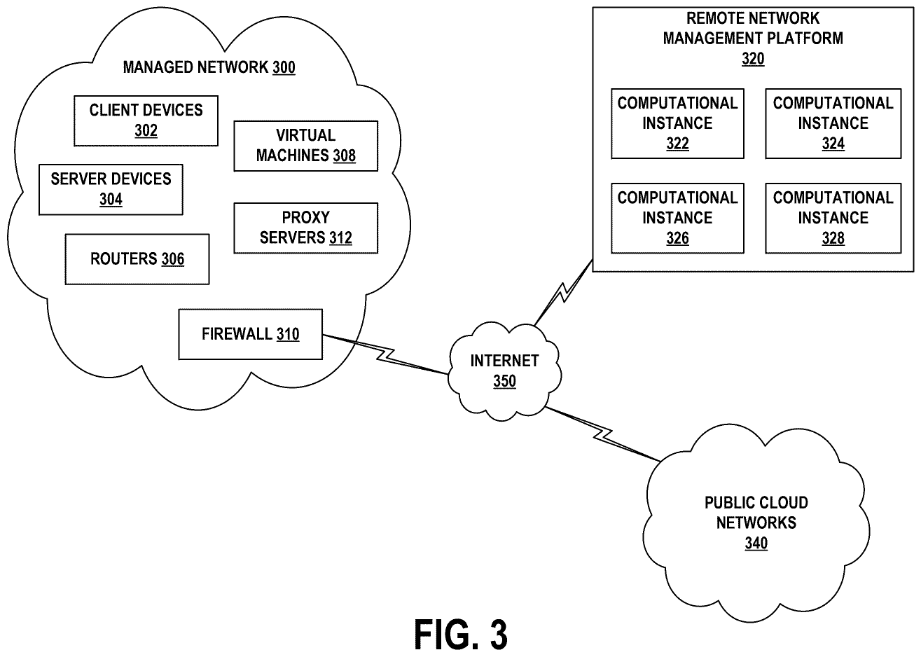

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers'data are separate from one another, the separation is enforced by the software that operates the single database. As a consequence, a security breach in this system may affect all customers'data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

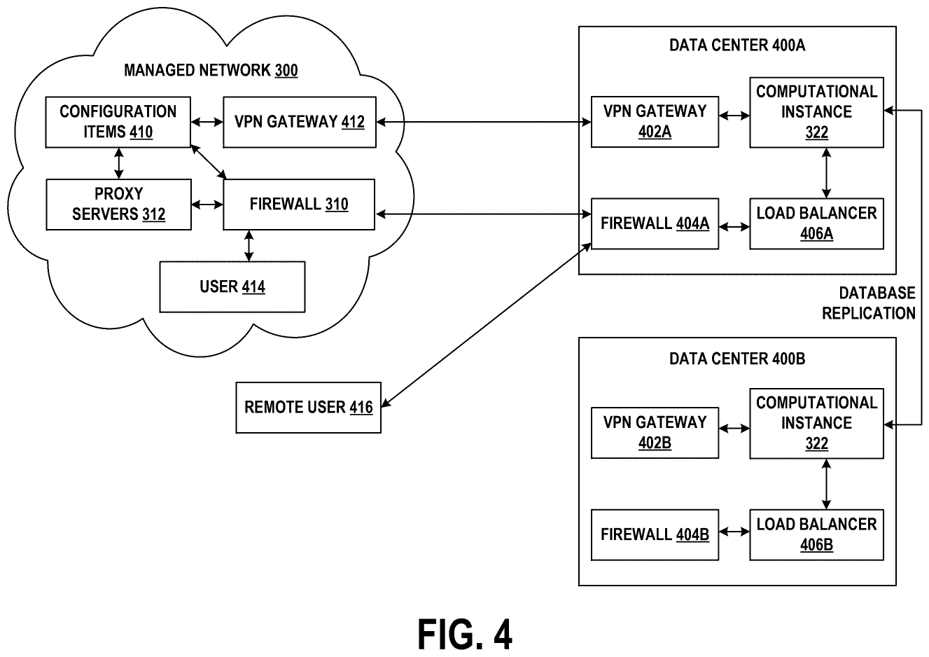

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

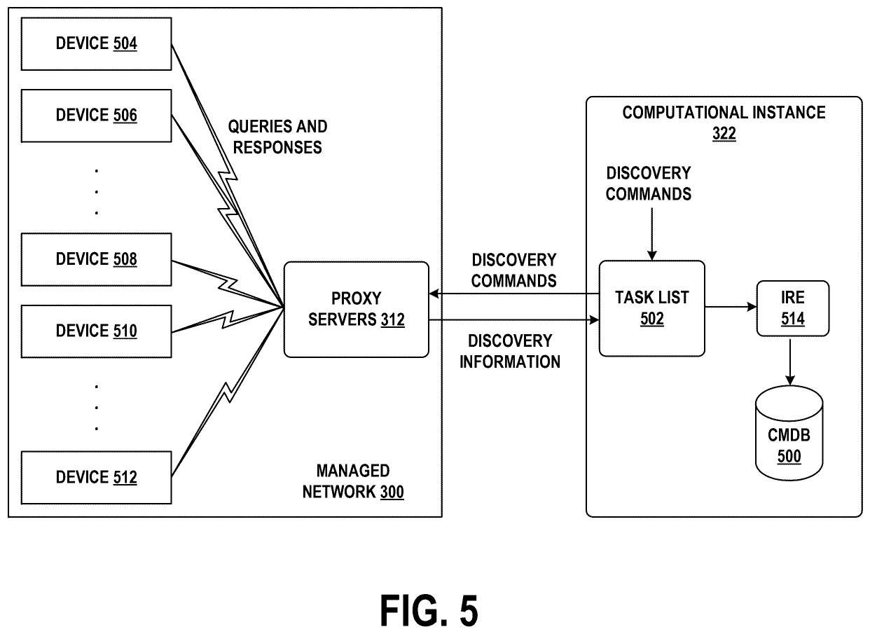

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery—horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®- 10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases - under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII. Example Platform Applications

As noted, remote network management platform 320 may support a number of applications and services, each of which may use or involve information from CMDB 500 and/or other databases as needed. Some of these applications and services may include task-based applications, workflows, user interface building tools, and agent interfaces, just to name a few. Other applications and services not explicitly discussed herein may benefit from the disclosed embodiments. Nonetheless, these task-based applications, workflows, user interface building tools, and agent interfaces are briefly described below to provide context for example embodiments of layered workflows discussed below.

### A. Task-Based Applications

Remote network management platform 320 may furnish various IT service management (ITSM) solutions including task-based applications designed to streamline and manage specific processes. Three examples are incident management, case management, and problem management.

Incident management focuses on the efficient resolution of IT service disruptions or incidents. When an issue or disruption occurs, it is logged as an incident in the incident management application. This application allows IT teams to track and manage these incidents throughout their lifecycles. It includes features such as incident creation/generation, assignment, prioritization, escalation, communication, and resolution. The incident management application provides workflows, notifications, and collaboration tools to facilitate the prompt and efficient addressing of incidents, with a goal of minimizing their impact on platform and system operations.

Case management is designed to handle diverse types of processes, requests, or workflows. It enables users to manage complex cases that require coordination across multiple groups. The case management application provides a unified platform to capture, track, and manage cases from initiation to resolution. It includes features such as case creation, classification, assignment, task tracking, collaboration, and closure. This application can be tailored to various use cases, such as HR inquiries, legal matters, facilities management, and customer support escalations among others.

Problem management is drawn to identifying and addressing the root causes of recurring incidents or issues. It helps IT teams identify underlying problems that lead to multiple incidents, analyze their impact, and initiate appropriate actions for resolution. The problem management application provides tools for problem identification, investigation, prioritization, and tracking. It allows users to link related incidents, perform root cause analysis, define workarounds or solutions, and track the progress of problem resolution. The application helps groups minimize the occurrence and impact of recurring issues, leading to improved service quality and stability for the platform and other systems.

### B. Workflows

As noted, task-based applications may employ or be integrated with workflows in some fashion. Here, a workflow defines a sequence of activities and operations used to automate and streamline processes. These workflows may include conditions and branching logic, enabling different paths within the workflow based on specific criteria, such as the values or states of variables or data.

Workflows can be integrated with other applications operable on remote network management platform 320, such as the task-based applications described above. This integration enables cross-application coordination and process synchronization. Further, remote network management platform 320 can integrate workflows with external systems and applications through web services or API calls. This allows for data exchange and collaboration with third-party tools, enabling end-to-end process automation and information sharing.

Remote network management platform 320 may include a workflow design application that allows users to create, modify, and manage workflows using a drag-and-drop user interface. The application provides a graphical representation of the workflow, making it easier to understand and configure the ordering of activities in the workflow. The application may also provide pre-built workflow templates and libraries that offer ready-to-use workflows for common processes. These templates can be customized to meet specific needs, thus accelerating the implementation of workflows.

### C. User Interface Building Tools

Remote network management platform 320 may provide a user interface builder application that is a visual design tool for creating and customizing user interfaces within the platform. This application may employ a low-code/no-code approach to designing intuitive GUIs, enabling administrators and developers to build user interface components without extensive coding knowledge.

Notably, low-code/no-code design refers to a development approach that enables the creation of software applications with minimal or no coding required. It involves using visual interfaces, drag-and-drop components, and declarative configuration instead of writing traditional lines of code.

Low-code platforms can provide a visual development environment that allows users to design and build applications through GUIs, pre-built components, and configuration options. They typically offer a set of pre-built functionalities and connectors to integrate with external systems, databases, and services. No-code platforms take the concept of low-code a step further by enabling users with little to no programming experience to create applications. These platforms offer a highly visual and intuitive interface where users can build applications using simple drag-and-drop actions, visual workflows, and configuration options. No-code platforms often provide a library of pre-built templates, modules, and integrations, allowing users to assemble and customize applications without writing any code.

Both low-code and no-code approaches aim to simplify and streamline the software development process, making it accessible to a broader range of users, including analysts, new developers, and subject matter experts. These approaches can empower non-technical users to create functional and scalable applications, reduce the reliance on traditional coding, and accelerate the development lifecycle.

To that point, the user interface builder application may include a drag-and-drop interface that simplifies the process of creating user interfaces. Users can add and arrange user interface components such as fields, buttons, containers, tables, and images onto the canvas, eliminating the need for manual coding. In doing so, the application may rely on a library of pre-built user interface components that users can choose from, including form fields, widgets, buttons, and navigation elements. These components can be added to the canvas and customized according to specific needs.

These user interface components may be bound to data sources within remote network management platform 320. This enables dynamic data display, real-time updates, and synchronization between the user interface and underlying data. The application also allows integration with other applications and workflows, as well as the use of conditional logic (e.g., visibility rules, triggering of actions, etc.) to create interactive and context-aware user interfaces.

### D. Virtual Agents

Remote network management platform 320 may also support virtual agents. These can be artificial-intelligence powered conversational interfaces designed to interact with users and provide automated assistance. Virtual agents can be integrated into various interfaces and applications, such as web portals, chat interfaces, and messaging platforms to offer self-service options and enhance the user experience. The virtual agents operable on remote network management platform 320 are different from the virtual agent features of a large language model (LLM). Notably, platform virtual agents may employ LLMs in some situations, but can also operate based on local platform content and pre-defined dialog trees, for example.

Virtual agents can engage in dynamic and context-rich conversations with users. They can guide users through predefined conversation flows, prompt for information, ask clarifying questions, and provide relevant responses or recommendations based on the user's needs. These virtual agents can be integrated with a knowledgebase, which contains a repository of articles, frequently-asked questions (FAQs), and troubleshooting information. Virtual agents can access this knowledgebase to retrieve relevant information and provide self-help resources to users. Virtual agents can also automate common tasks or processes within the platform. They can initiate workflows, create tasks, perform system actions, or provide status updates, allowing users to complete tasks without manual intervention.

Further, virtual agents can transfer conversations to live (human) agents when necessary or desirable. If a virtual agent cannot resolve a user's query or if the user requests human assistance, the conversation can be handed off to a live agent for further support and resolution. Such a handoff may involve providing, to the live agent, the context (and possibly some or all of the content) of the conversation between the user and the virtual agent.

### VIII. Example Workflows

As noted above, workflows can be automated or semi-automated multi-step processes that occur between any combination of people and computing systems. A given organization can routinely use a large number of workflows for various purposes, such as HR onboarding, expense approvals, and IT incident management just to name a few.

Workflows may be defined by way of remote network management platform 320 as state diagrams. Thus, each workflow may have a number of states and transitions therebetween. Certain automated actions may be performed in various states, such as setting values, executing a script, sending a notification, starting or stopping a timer, communicating with third-party remote servers, transitioning to a different state, and so on. Other actions may be triggered by state transitions. Some of these actions may involve waiting for user input, while others could be automated.

Additionally, each workflow may have one or more triggers (e.g., starting rules) that causes the workflow to initiate. These triggers can be based on any one or more of: user actions (e.g., a user requests the workflow to initiate), time and/or a schedule (e.g., a computing system is configured to initiate the workflow once per day), system monitoring exceptions (e.g., detection of an error on system operation or a parameter crossing a pre-defined threshold value), and/or other events (e.g., changes to a filesystem or a database, reception of a message, calling of an API function).

These workflows may be executed by a computational instance (e.g., computational instance 322 of remote network management platform 320). Thus, users may interact with workflows by way of one or more user interfaces of the computational instance. This may involve a user being notified by the computational instance (e.g., via email) that their input is needed for a particular work item that is in a particular state of a workflow. The user can then log on to the computational instance and enter the requested input through an appropriate user interface. In some cases, the user may also be able to view other parts of the workflow related to the work item, e.g., its values or actions from other states and/or a representation of its history.

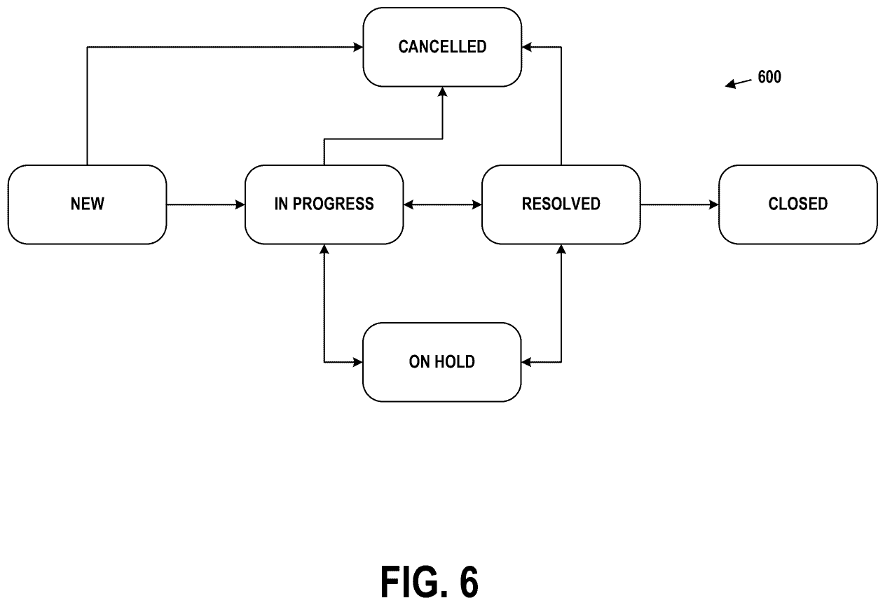

FIG. 6 depicts an example workflow 600, in which the boxes represent discrete states and the arrows between these states represent transitions. This workflow represents that of an IT incident of an incident management application. Such an incident may be created by a technology user who has encountered a problem (e.g., software not working properly on their laptop, a network service that is not reachable) or automatically generated when an outage is detected.

The states can be defined as follows. In the new state, the incident has been created but not yet investigated. In the in progress state, the incident has been assigned to an agent, and is being investigated or is scheduled for investigation. In the on hold state, the responsibility for the incident shifts temporarily from the assigned to another entity (e.g., the user or another agent) to provide further information, evidence, or a resolution. In the resolved state, the incident has been addressed by the agent. In the closed state, the incident has been confirmed to be satisfactorily resolved. In the cancelled state, the incident was triaged but found to be a duplicate incident, an unnecessary incident, or not representing an actual problem. Each incident may progress through this workflow from the new state to either the cancelled state or the closed state. Such an incident may be assigned to an agent who is tasked with addressing the incident.

Incidents may be stored in a data structure (e.g., a row of an incident table in a database). This data structure may include the following information in its fields (e.g., columns of the incident table): number (a unique identifier for the incident, auto-generated by an incident management application), caller (the entity that reported the issue or the affected user), short description (a brief summary of the incident, outlining the issue in a few words), description (a detailed explanation of the incident, including any relevant information or steps to reproduce), priority (the urgency and impact level of the incident, specifying how quickly it should be addressed), state (the current status of the incident, such as new, in progress, resolved, or any other states in workflow 600 or in any other workflow), assignment group (the group responsible for resolving the incident), assigned to (the specific individual responsible for resolving the incident), category (the classification of the incident by type, such as network, software, or hardware), subcategory (a more detailed classification under the main category, helping further define the incident), affected configuration item (the specific configuration item affected by the incident—this links the incident to an asset or service represented in the CMDB), resolution notes (a field for documenting how the incident was resolved or what actions were taken), and opened date (the date and time when the incident was created or reported). Other fields may be stored in such a data structure, and—in general—more or fewer fields may be present.

Workflow 600 is just one possible incident management workflow. Other such workflows involving more or few states and/or transitions may be possible. Workflow 600 also serves as a simple example of more complicated workflows that go beyond just incident management.

Data related to each work item that is processed by a workflow may be logged, saved, or otherwise stored by the computational instance hosting the workflow. For example, data related to the states and transitions used by each work item, how much time each work item stays in each state, the user or users associated with each work item, and so on may be written to one or more logs. These logs may exist as files in a filesystem, entries in a database, or in some other form.

Workflows can be presented on a GUI through a combination of visual and interactive GUI elements. These workflows may be displayed using flowchart-like diagrams where each step in the workflow is represented by distinct nodes or icons. These nodes are connected by lines or arrows indicating the sequence of operations and the flow of data or actions from one step to the next (for example, workflow 600 may be presented on a GUI largely as shown in FIG. 6). Each node may be labeled with a descriptive name and may include additional details or parameters that can be viewed or configured through pop-up windows or side panels.

Some workflows employ a step-by-step approach, presenting users with a series of interconnected pages (e.g., web pages) or screens that guide them through each stage of the workflow. Each page may focus on a specific task or set of related tasks. The GUI for such workflows often begins with a welcome or introductory screen that outlines the overall workflow and provides an overview of the steps involved. Navigation controls, such as “Next”, “Previous”, “Cancel”, and “Finish” buttons, may be displayed to allow movement forward and backward through the workflow or exit if necessary. Progress indicators, such as a step-by-step sidebar or breadcrumb trail, can be used to show the current position within the workflow and what steps remain.

Workflows may be implemented with program logic (e.g., scripts) that query specific fields of database tables for information relevant to the workflow and then provide this information along with further context for display by a GUI framework (e.g., a program or set of programs that produce a GUI from a programmatic specification thereof). In some cases, the database table names, field names, and GUI framework may be referenced indirectly by metadata. This allows a more flexible and implementation-independent interface between the program logic of the workflow and different types of databases and GUI frameworks.

### IX. Layered Workflows

The embodiments herein introduce layered workflows that can be used to define variants of an existing workflow based on conditions. Layered workflows are more than just adding conditional processing or states to a workflow. Instead, they can be thought of as a filter applied atop a parent workflow to derive a child workflow. The child workflow overrides the processing of one or more states and transitions, adds new states to the parent workflow, and/or removes states from the parent workflow. Changes made to a parent workflow (e.g., in the processing of a state or the addition or removal of a state) may be automatically applied to all of its child workflows, but changes to a child workflow are not automatically applied its parent workflow. Put another way, child workflows typically inherit the properties of their parent workflows, but parent workflows do not inherit the properties of their child workflows.

An exception to the general rule of child workflows inheriting changes made to their parent is when a state in the child workflow has been overridden with new processing (e.g., a new starting rule). Then any changes made to the state in the parent workflow are not automatically inherited by the child workflow. The overridden state in the child workflow may be referred to as “dirty” since it does not match that of its parent, and thus changes to this state in the parent workflow may not apply or be relevant to this “dirty” state.

In some cases, permission to change a parent workflow is limited to one group of users, whereas permission to change a child workflow of this parent workflow may be granted to a larger and/or different group of users. This means that different subsets of users may be granted different capabilities to change parent and child workflows. As one possible example, a first group of users may be the only users with permission to change a parent workflow, while anyone from the first group of users and a second group of users have permission to change the child workflow. Likewise, just a third group of users may be the only users with permission to change a second child workflow of the parent workflow. Since changes to a parent workflow impacts all of the parent workflow's child workflows, these hierarchical permission structures minimizes the likelihood that an accidental or improper change is made to a parent workflow.

There are a number of technical advantages to layered workflows. Suppose that a parent workflow needs to be implemented within a large entity that has four departments and three geographies. Each combination of department and geography requires a modification to the parent workflow. Thus, there are twelve possible distinct workflows.

In previous scenarios, this would require that twelve workflows be developed, tested, and deployed, and then updated as needed. But doing so quickly becomes highly complicated, as any changes to the basic workflow structure (i.e., what would be the parent workflow) must be propagated to each of the other workflows. Further, twelve workflows take up significantly more memory (e.g., twelve times as much) than a single workflow.

Alternatively, a single workflow with conditional states, transitions, and processing could be developed to handle all twelve scenarios. However, doing so leads to a very complicated single workflow that is not robust in the presence of change. For example, to deploy a change for one of the geographies, all twelve scenarios would have to be retested in order to ensure that the change does not have an unintended impact on the workflows for the other geographies. This leads to “spaghetti logic” that is difficult to modify and debug. Further, a single workflow would not be able to support the permission-based editing features discussed herein.

Layered workflows address these disadvantages. Twelve child workflows can be derived from a single parent workflow. Each child workflow need only be specified in terms of its differences from the parent workflow, thus saving memory as the whole workflow is not reproduced for each child workflow. Further, as noted above, permission controls can be put in place so that the impact of any change to a child workflow is limited just to that child workflow and not any other child workflow.

### A. Example Child Workflows

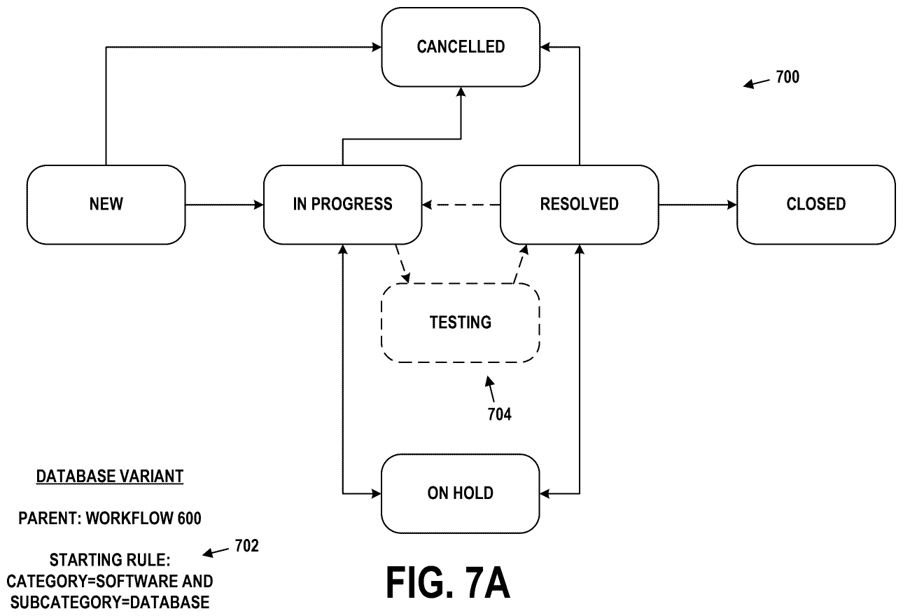

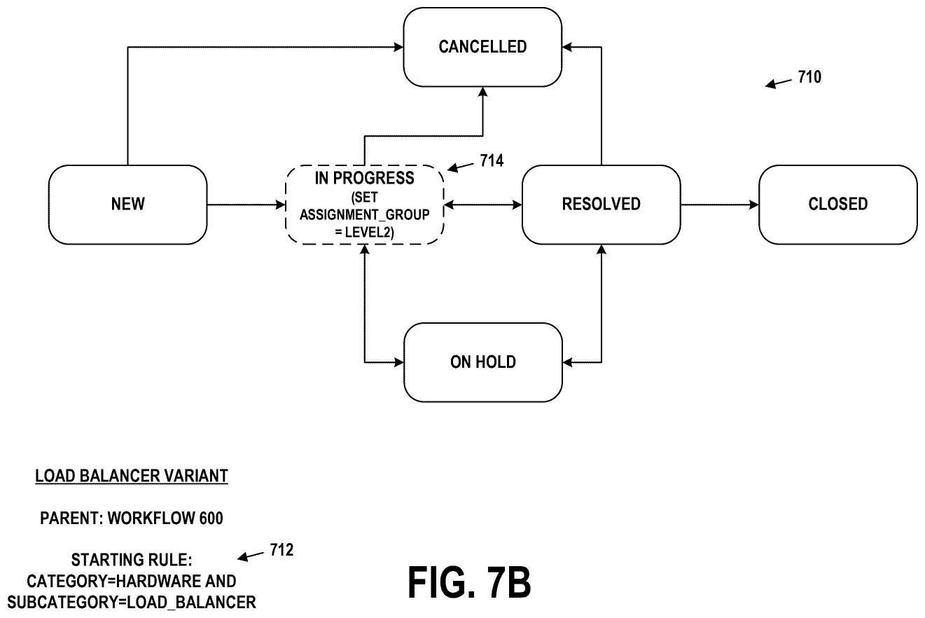

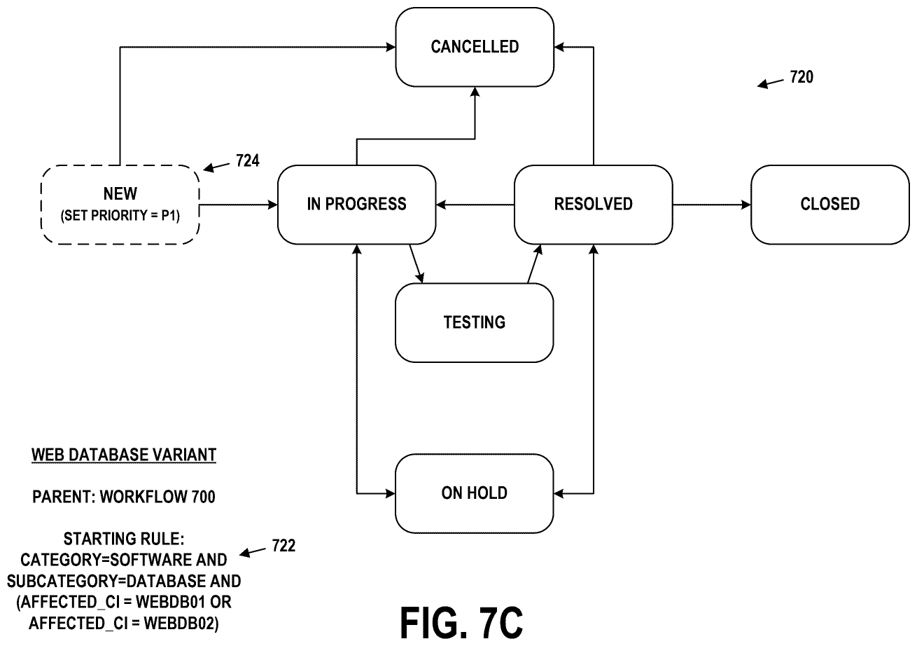

FIGS. 7A, 7B, and 7C depict workflows 700, 710, and 720 that are variants of workflow 600. Thus, workflow 600 serves as parent workflow to each of workflows 700, 710, and 720. As will be described below in the case of workflow 700, workflows 700, 710, and 720 may have their own respective child workflows as additional variants. In general, any child workflow can have its own child workflows, resulting in a hierarchy of workflows.

As shown in FIG. 7A, workflow 700 is referred to as a “database variant” of workflow 600. Workflow 700 is associated with starting rule 702, which define the conditions under which workflow 700 is executed. Notably, starting rule 702 indicate that workflow 700 is executed when the category field of an incident is “software” and the subcategory field of the incident is “database”. Workflow 700 inherits all states of workflow 600, and adds the testing state 704 as well as modifications to the transitions between testing state 704 and other states. Thus, workflow 700 contemplates the situation where all incidents relating to a database require some additional level of testing (e.g., quality assurance) before they are considered to be resolved.

As shown in FIG. 7B, workflow 710 is referred to as a “load balancer variant” of workflow 600. Workflow 710 is associated with starting rule 712, which define the conditions under which workflow 710 is executed. Notably, starting rule 712 indicate that workflow 710 is executed when the category field of an incident is “hardware” and the subcategory field of the incident is “load_balancer”. Workflow 710 inherits all states of workflow 600, and modifies (or overrides) the in progress state 714 to set the assignment_group for an incident to “level2”. Thus, workflow 710 contemplates the situation where all incidents relating to a load balancer are initially assigned to level 2 support agents (e.g., agents with more specific expertise in certain areas) as opposed to level 1 support agents (e.g., agents who are generalists).

As shown in FIG. 7C, workflow 720 is referred to as a “web database variant” of workflow 700 (thus workflow 700 is both a child workflow and a parent workflow). Workflow 720 is associated with starting rule 722, which define the conditions under which workflow 720 is executed. Notably, starting rule 722 indicate that workflow 720 is executed when the category field of an incident is “software”, the subcategory field of the incident is “database”, and the affected configuration item (“affected_ci”) field of the incident is either “WEBDB01” or “WEBDB02”. Here, it is assumed that “WEBDB01” or “WEBDB02” are configuration items for databases supporting web services. Workflow 720 inherits all states of workflow 700, and modifies (or overrides) the new state 724 to set the priority for an incident to “P1”. Thus, workflow 700 contemplates the situation where all incidents relating to specific databases are assumed to be of the highest priority (e.g., due to these databases providing a critical service).

In general, when a workflow is triggered to begin (e.g., via user input, addition of a record to a database table, or some other event), the computational instance may determine which variant of the workflow to execute. This could be the base variant represented by the parent workflow or any variant represented by a child workflow derived from the parent workflow, either directly or indirectly (e.g., child workflows, child workflows of child workflows, and so on).

Each variant is expected to have its own starting rule that are unique and disjoint from the starting rules of all other sibling variants. In other words, of the starting rules for each sibling child workflow, only one will match any given data on which the starting rules are evaluated. Thus, selection of a variant may proceed as follows. For the parent workflow, the starting rules of it and/or each of its direct child workflows may be evaluated. This evaluation may consider any data that is available to the computational instance. In the case of workflows 600, 700, 710, and 720, the information may be from an incident record as stored in a database table. But other data could include user input, records from other database tables, configuration or environmental information of the computational instance, information from a remote system, and so on. The starting rules for variants may include Boolean expressions (as provided herein for purposes of example), arithmetic expressions, regular expressions, or some other form of expression.

Regardless, if there are no matches of the starting rules of the direct child workflows, the parent workflow may be executed. If there is a match of a direct child workflow, the starting rules of that child workflow's child workflows may be evaluated. This process continues by traversing the hierarchy of workflows from the ultimate parent workflow until the most specific matching child workflow is found. Then, that most specific workflow is executed.

In some cases there may be multiple matching child workflows despite each child workflow having disjoint starting rules. For example, suppose that one sibling child workflow has the starting rule condition of A and B both being true, and another sibling child workflow has the starting rule condition of A being true and B being false. If the value of B is not known, it is unclear which child workflow should be executed. In these situations, the child workflows may be ordered (e.g., numerically from 1 to n) and the child workflow with the lowest value in the ordering may be selected for execution.

For example, consider workflows 600, 700, 710, and 720. If an incoming incident has a category field of “software” and a subcategory field of “database”, workflow 700 is selected. Since workflow 720 is a child of workflow 700, the starting rule of workflow 720 is evaluated. Thus, if the incoming incident also identifies the affected configuration item to be either of “WEBDB01” or “WEBDB02”, then workflow 720 is executed. Otherwise, workflow 700 is executed. If an incoming incident has a category field of “hardware” and a subcategory field of “load-balancer”, workflow 710 is executed (unless workflow 710 has its own child workflows, which would result in these child workflows being evaluated for execution). All other incidents would not match any of the child workflows, which would cause parent workflow 600 to be executed (assuming that workflows 700, 710, and 720 are the only child workflows).

In some situations, the evaluation of which workflow variant to execute may be deferred. For example, the data used to evaluate starting rules might not be available when the workflow begins. In these cases, all parent and child workflows may follow a common set of one or more states and transitions until such an evaluation can be made. As an example, suppose that a workflow variant is selected based on a geographical region of the user which is engaged with the workflow (e.g., an agent addressing an incident). But this geographical region might not be known until the user identifies themselves or provides their geographical region when the workflow is in a particular state. Once the geographical region is known, workflow selection can occur. As an example, suppose that the first state of a parent workflow requires that the user identify their geographic region. Then, at the second state or a subsequent state of the parent workflow, one or more child workflows may be evaluated and possibly selected for execution based on the user's input.

In some cases, decision tables may be used to decouple starting rules from workflows. Decision tables may be implemented as a matrix of inputs and outputs, where each row represents a decision rule. The columns may include conditions (inputs) and actions (outputs). For example, in an incident management system, there may be a decision table that determines the assignment group for an incident based on inputs such as the category and priority of the incident. Thus, each combination of category and priority of the incident can be mapped to a priority level (e.g., P1, P2, P3, etc., where P1 are the highest priority, P2 are the second highest priority, P3 are the third highest priority, and so on). Another decision table might map the geographic region of the user who opened or has experienced the incident to an assignment group in the same or a nearby geographic region.

Although the examples of workflows 700, 710, and 720 only depict addition of a new node to a parent workflow, adding of new transitions to a parent workflow, and overriding of the programmatic logic of a parent workflow (e.g., an overridden state or transition), child workflows may differ from their parent workflows in various ways. For instance, a child workflow could remove a state from a parent workflow and/or rearrange the transitions of a parent workflow. Other possibilities exist.

Notably, the examples provided herein are focused on incident management workflows for purposes of simplicity and presentation. However, other types of task-based applications, user interface building applications, and/or other applications may benefit from these embodiments. Thus, the embodiments herein are not limited to just the examples shown and discussed.

### B. Example Hierarchical Data Structure

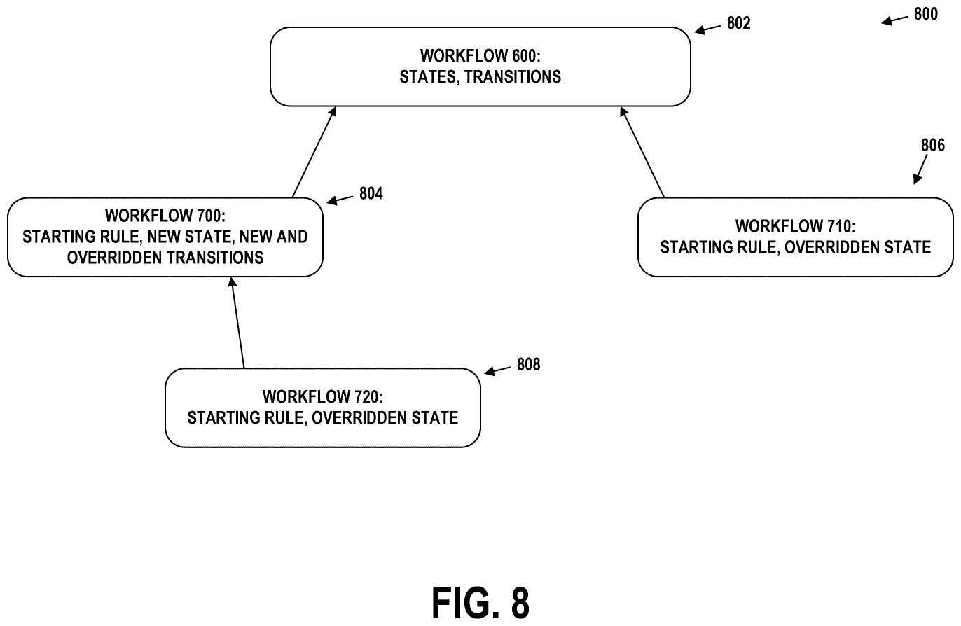

FIG. 8 depicts an example hierarchical data structure 800 for storing information regarding the states, transitions, starting rules, other aspects of workflows 600, 700, 710, and 720. Data structure 800 takes the form of a tree, with workflow 600 as root node 802 (because workflow 600 is the ultimate parent workflow from which all child workflows are derived), workflows 700 and 710 as child nodes 804 and 806 of root node 802, and workflow 720 as a further child node 808 of workflow 700 (because workflow 720 was derived from workflow 700).

This hierarchical arrangement is memory-efficient. The states and transitions of workflow 600 are stored in or referenced by root node 802. Child nodes 804, 806, and 808 do not duplicate this information, and instead refer (point) to root node 802 as shown. However, child nodes 804, 806, and 808 represent the modifications of their respective workflows compared to that of their immediate parents. Thus, child node 804 represents the starting rule, new state (704), and new and overridden transitions of workflow 700 with respect to workflow 600. Child node 806 represents the starting rule and overridden state (714) of workflow 710 with respect to workflow 600. Child node 808 represents the starting rule and overridden state (724) of workflow 720 with respect to workflow 710.

Advantageously, this arrangement is a significant improvement in memory utilization over that of prior techniques that required duplicating the entire workflow for each variant. In those cases, a workflow with n variants would require at least n times the memory of the base variant. Here, since just the changes (deltas) associated with each child workflow with respect to its parent are stored for that child workflow, far less than n times the memory of a variant is required. For instance, if the base variant requires 100 kilobytes (K) of memory, the naïve approach of prior techniques would result in utilization of at least 400K of memory. However, if the changes to each child variant requires about 10K of memory, then this data structure needs only 130K of memory—an improvement of over 67% in terms of memory efficiency. In a computational instance supporting hundreds or thousands of workflows, this savings can be significant.

### C. Example User Interfaces

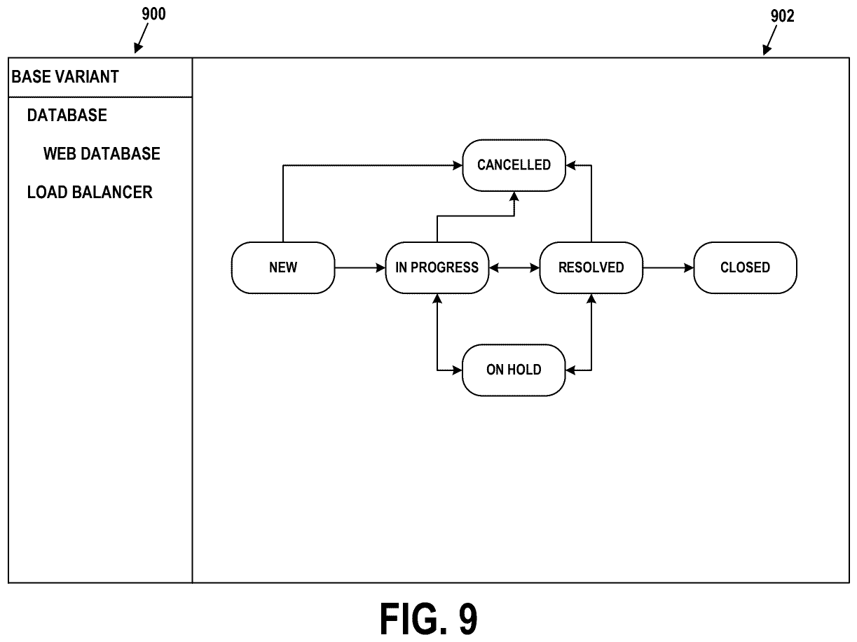

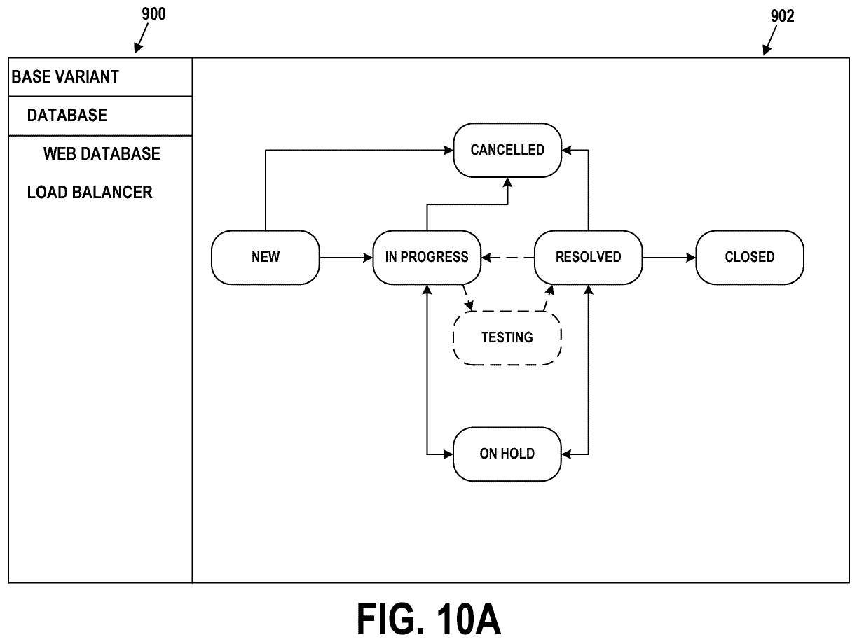

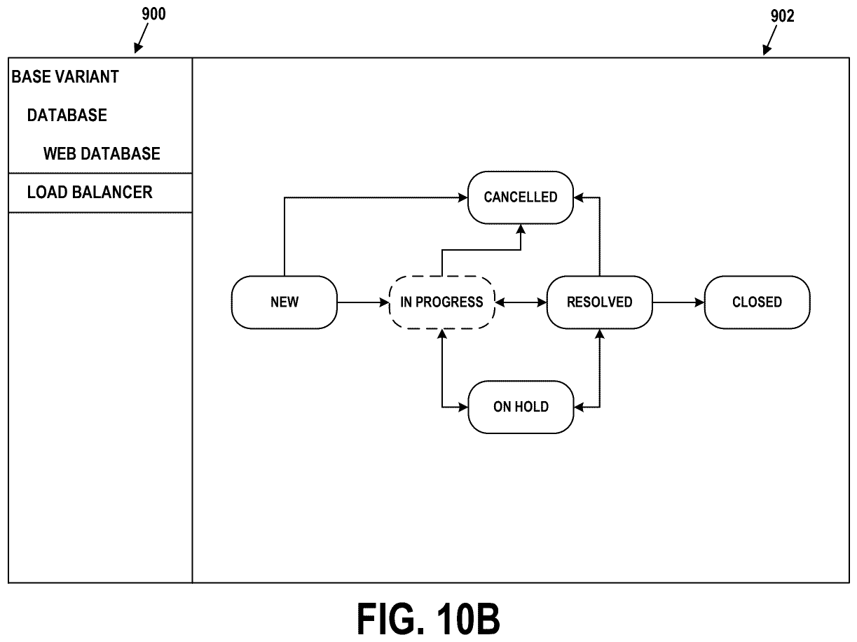

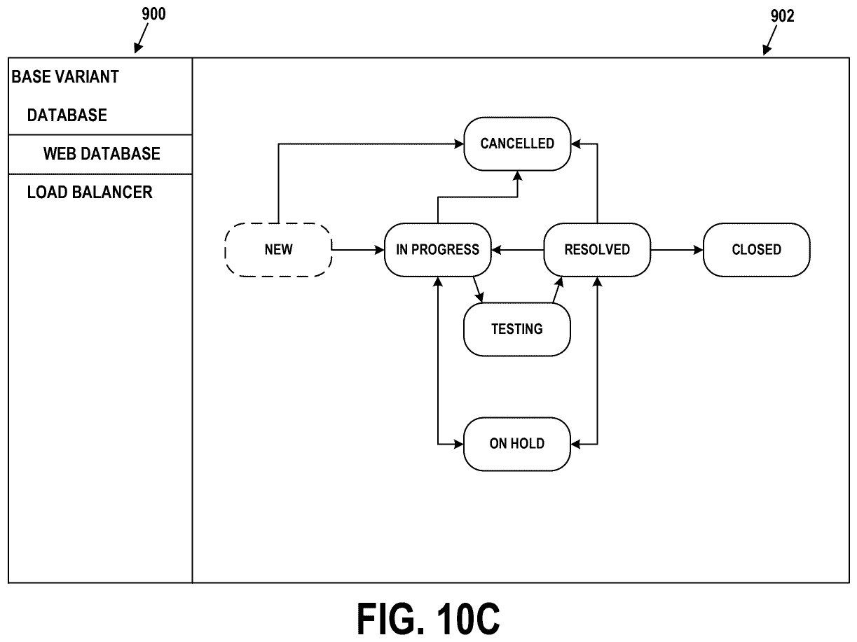

FIGS. 9, 10A, 10B, and 10C depict GUIs that allow a workflow designer or other user to efficiently navigate between workflow variants. As noted above, remote network management platform 320 may include a workflow design application that allows users to create, modify, and manage workflows using a drag-and-drop user interface.

These GUIs each depict selection panel 900 and display panel 902. Selection panel 900 represents the name of each of the workflow variants in an indented menu fashion that reflects their hierarchy, and allows selection of a variant from this menu (e.g., by actuating the respective location of the variant's name in selection panel 900). Display panel 902 represents a visual flow chart of the selected workflow variant (e.g., similar to what was shown in FIGS. 6, 7A, 7B, and 7C, respectively). In FIG. 9, workflow 600 is shown in display panel 902 because the base variant is selected in selection panel 900.

This visual flow chart can be edited for each variant by actuating the various states and transitions. In this manner, states, transitions, starting rules, conditions, and other characteristics of a workflow variant can be added, revised, and/or removed. For instance, actuating the in progress state in display panel 902 of FIG. 9 may cause a popup or overlay window to appear allowing the workflow designer or other user to make these edits.

In FIG. 10A, workflow 700 is shown in display panel 902 because the database variant is selected in selection panel 900. While the states and transitions from workflow 600 (the parent workflow of workflow 700) are shown, the changes made in workflow 700 are emphasized with dotted lines (in other examples, the emphasis can be made through use of different colors, fonts, sizes, or shading between the parts of workflow 600 that have changed and those that remain the same).

In FIG. 10B, workflow 710 is shown in display panel 902 because the load balancer variant is selected in selection panel 900. While the states and transitions from workflow 600 (the parent workflow of workflow 710) are shown, the changes made in workflow 710 are emphasized with dotted lines.

In FIG. 10C, workflow 720 is shown in display panel 902 because the web database variant is selected in selection panel 900. While the states and transitions from workflow 700 (the parent workflow of workflow 720) are shown, the changes made in workflow 720 are emphasized with dotted lines.

Advantageously, these GUIs allow the workflow designer or other user to select a workflow variant for further examination and to easily identify the differences between workflow variants. As noted above, individual users may be given different levels of permission with respect to whether they can view or edit workflows. Further, and not shown in FIGS. 9, 10A, 10B, and 10C, the GUIs may include widgets or other mechanisms for adding new variants at a specific point in the hierarchy, deleting variants, and copying variants.

### X. Additional Features

In conjunction with any of the features above, one or more of the following additional features may be implemented. Each of these features incorporate further functionality and technical advantages.

### A. Workflow Rewind

In some cases, a workflow can be “rewound” or “replayed” from an earlier state resulting in a different variant being used. For example, suppose that a parent workflow consists of a linear sequence of states, 1, 2, 3, 4, 5, and 6. Suppose further that a child workflow of this parent workflow replaces states, 3, 4, 5, and 6 with new states 3′, 4′, 5′, and 6′, also in a linear sequence. A condition (e.g., a starting rule with deferred evaluation) is evaluated in state 2 in order to determine which of these variants (parent or child) is followed in any given execution.

In some situations, the condition may initially indicate that the parent workflow should be executed. Therefore, the workflow progresses through at least some of states 3, 4, 5, and/or 6. In any of these states, it may be determined that—perhaps based on new information—the condition should be reevaluated. The user would be given the option to rewind the workflow back to state 2 in order to perform this reevaluation. If the condition now indicates that the child workflow should be executed, the workflow will progress through states 3′, 4′, 5′, and 6′. The rewinding may be implemented as the user selecting state 2 by way of a graphical user interface and/or otherwise indicating that that the workflow should be rewound to state 2.

This scenario is common in incident management situations where incidents of different priorities are handled according to different workflow variants. An incident that is initially given one priority (e.g., P2) may be handled according to one workflow variant. Upon further investigation, the incident may be determined to actually be of a different priority (e.g., P1). The user may rewind the workflow to a point at which a condition involving incident priority (e.g., a starting rule) is evaluated, and update the incident to have the new priority. Then, the workflow variant associated with this new priority will be executed.

To facilitate this rewind feature, some or all states may be associated with rewind rules that indicate whether the processing of the state should be executed (i) each time the work item is in the state, (ii) only if the processing has not been executed previously for this work item, or (iii) or only on the first time that the work item is in the state. This reduces repeated processing and allows states to effectively be skipped when a workflow is rewound and they do not need to be executed more than once.

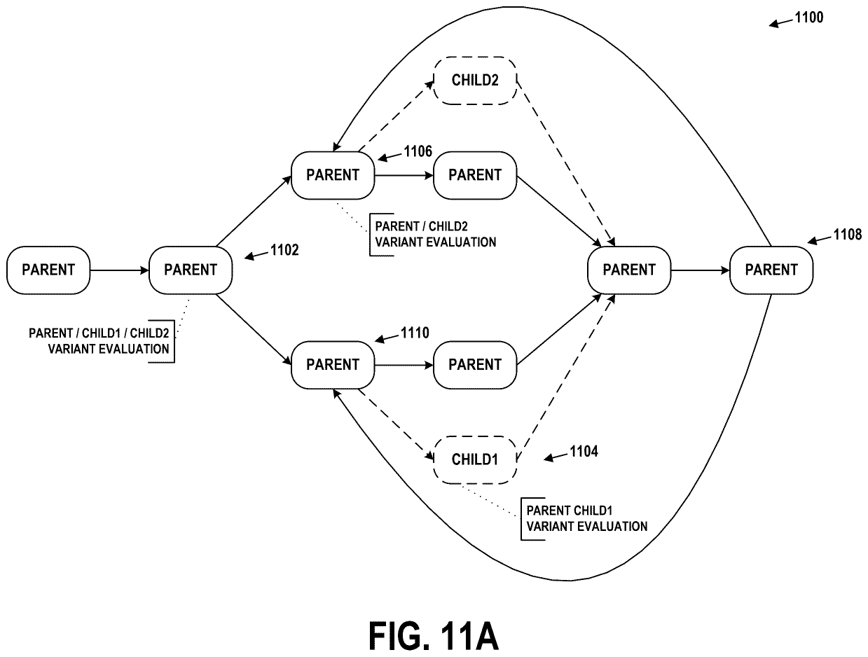

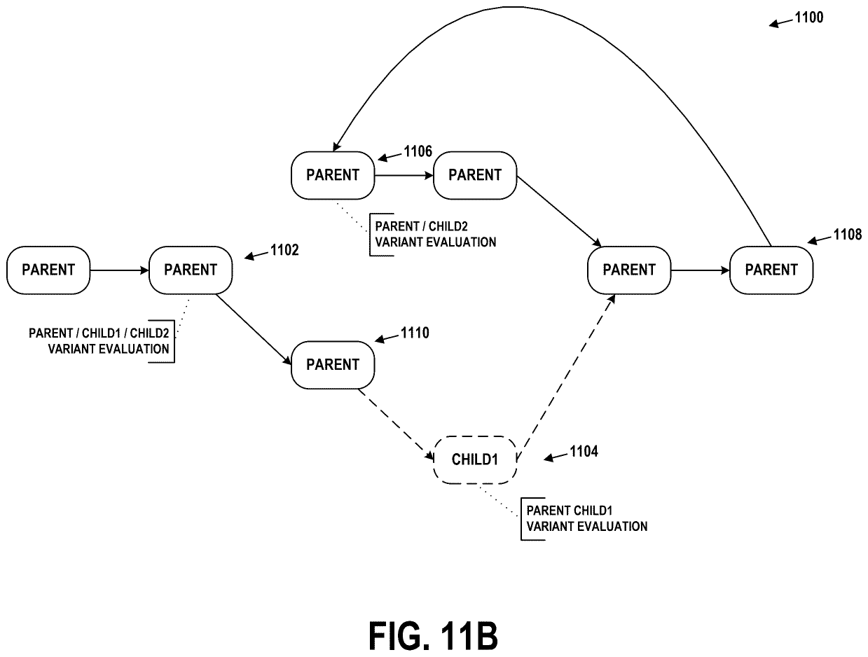

FIGS. 11A and 11B provide an example. FIG. 11A depicts a combined workflow 1100 including a parent workflow that has two child workflows, child1 and child2. The child1 and child2 variants are siblings, in that neither is a parent of the other. The leftmost state (the state to the left of state 1102) is assumed to be the starting state of combined workflow 1100. State 1108 is assumed to be the ending state of combined workflow 1100.

Each state (node) in combined workflow 1100 is marked to indicate whether it is of the parent workflow or unique to either of the child1 or child2 workflows. In accordance with the discussion above, the child1 and child2 workflows include all states of the parent workflow but not the states unique to the other child. Additionally, the child states and transitions into and out of these child states are presented in dashed lines to indicate that they are optional.

Also, states 1102, 1104, and 1106 each have callouts indicating that they are states in which an evaluation is made in order to determine which variant to execute. Thus, in state 1102, the evaluation is between the parent, child1, and child2 workflows. In state 1104, the evaluation is between the parent and child1 workflows. In state 1106, the evaluation is between the parent and child2 workflows.

In combined workflow 1100, there are two possible rewind paths indicated by the arcs from state 1108 to state 1110 and from state 1108 to state 1106, respectively. Thus, when in state 1108, the executing workflow can be rewound to either state 1110 or state 1106 (or it may end, though that option is not explicitly shown).

FIG. 11B depicts a traversal (execution) of workflow 1110. Notably, states and transitions not used by the traversal are removed for purposes of illustration (these states and transitions still exist in the workflow).

It has been assumed that the evaluation of state 1102 resulted in the child1 workflow being selected. Thus, the traversal proceeds to state 1110, then state 1104 (where child1-specific processing may take place), then follows the transitions to state 1108. In state 1108, the workflow is rewound to state 1106. Since the workflow being executed is the child1 workflow and the evaluation in state 1106 is between the parent and child2 workflows, the child1 workflow continues to be executed (i.e., control does not pass to a different workflow due to the rewind). Thus, the child1 workflow proceeds by following the transitions back to state 1108. At that point, another rewind may take place (e.g., to either of states 1106 or 1110), or the child1 workflow may terminate (because state 1108 is an ending state).

Notably, FIGS. 11A and 11B depict just one rewind scenario. Other scenarios, simpler or more complicated, may exist.

### B. Workflow Rewiring

Workflow applications may employ various types of metadata to assist the rendering of workflows and workflow variants on a graphical user interface. For instance, the metadata may indicate that two states that are connected by a transition should appear adjacent to one another or at least near one another when the workflow is displayed on the graphical user interface. Various positioning algorithms may be used to select the locations of these states and transitions, and their locations may be manually modified by a user (e.g., the user can drag a state or transition from one location to another).

In cases where a state is deleted from a workflow, the transitions into and out of that state may be combined. For example, suppose that a workflow consists of a linear sequence of states, 1, 2, and 3, with transitions from state 1 to state 2 and from state 2 to state 3. If state 2 is removed from the workflow, a transition from state 1 to state 3 may be automatically added. Alternatively, a hidden transition may be added between state 1 and state 3. This hidden transition would not be displayed on the graphical user interface, or may be displayed differently from other transition (e.g., grayed out or with a dotted line). The hidden transition prevents a positioning algorithm from repositioning state 1 and state 3 to be further apart, and serves to remind the user that they may want to create an explicit transition between state 1 and state 3.

In cases where there are more than a threshold number of transitions into and out of a state that is deleted, having one or more hidden transitions serve to hold the preceding and subsequent states in place on the graphical user interface while the user decides how to connect these states. These issues are even more complicated when the deleted state appears in multiple workflow variants, each potentially with different sets of transitions.

### C. Workflow Inheritance and Editing

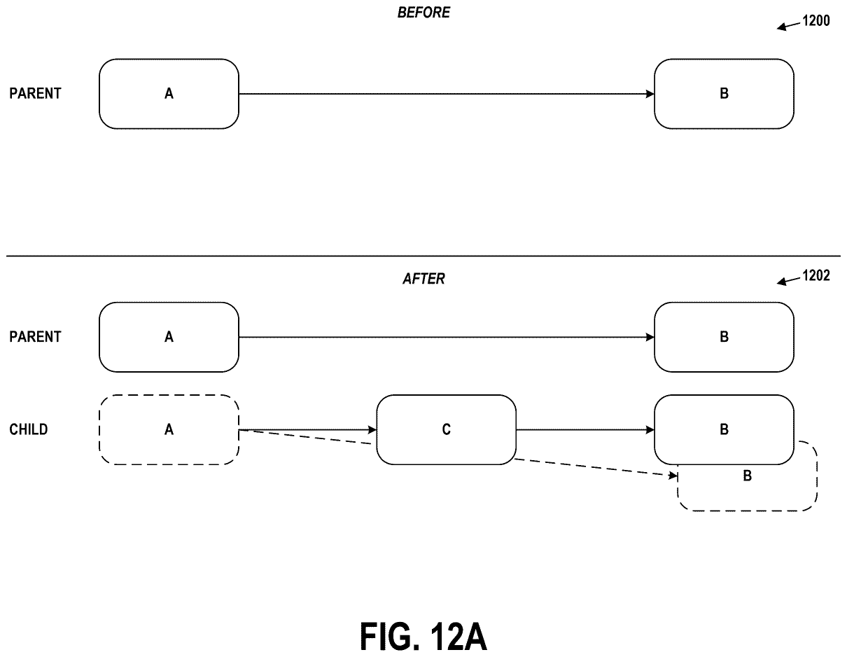

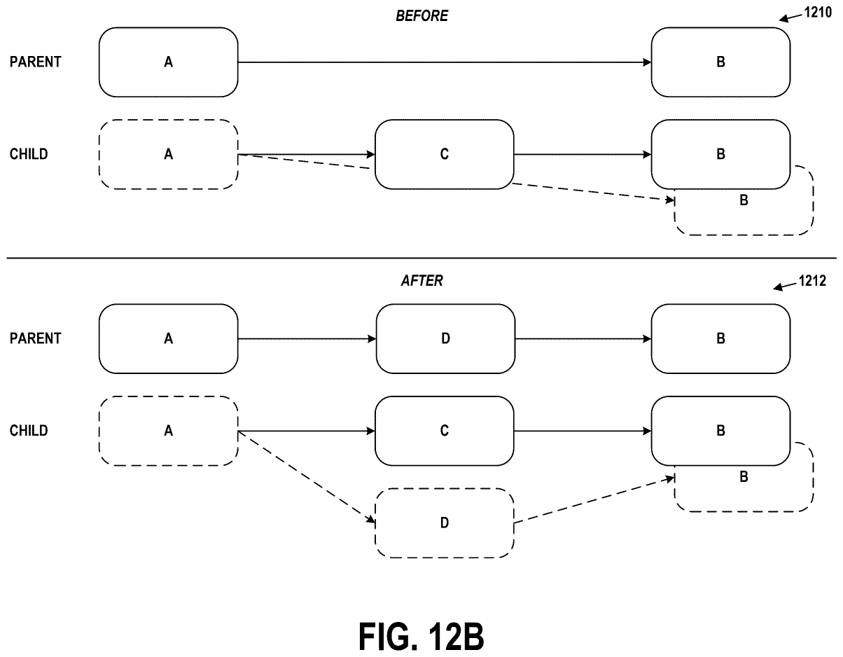

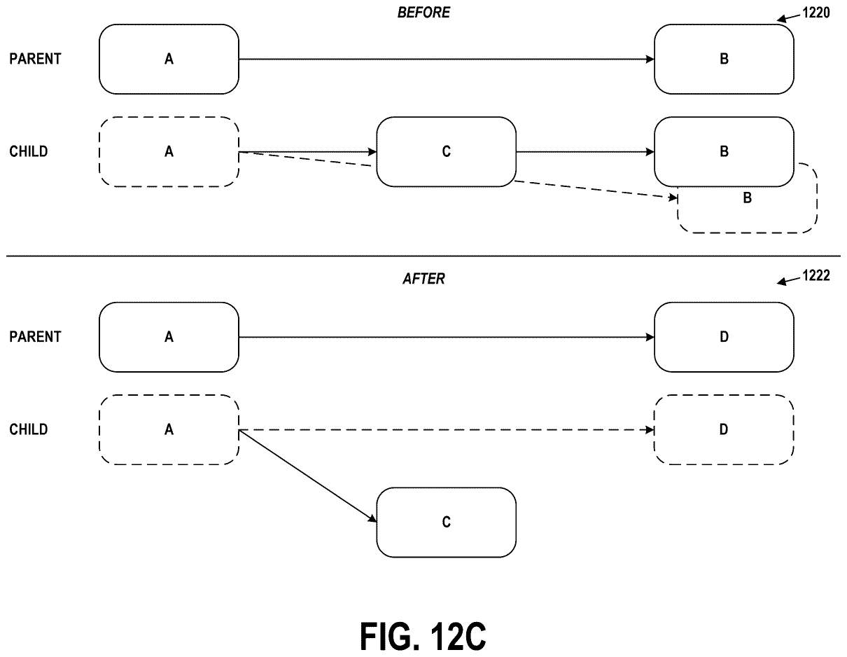

FIGS. 12A, 12B, and 12C depict examples of workflow inheritance in the presence of workflow editing. These examples illustrate before and after scenarios for several distinct features of layered workflows.

FIG. 12A depicts before status 1200 in which a parent workflow consists of states A and B with a transition from state A to state B. After status 1202 depicts addition of a child workflow as a variant to the parent workflow. Notably, the child workflow initially inherits states A and B, as well as the transition from the parent workflow. However, state C has been added to the child workflow, also with transitions from state A to state C and from state C to state B. Further, state B has been overridden (e.g., with new processing and/or starting rules). In after status 1202, the states and transitions of the parent workflow are shown with dashed lines to visually differentiate between what has changed from and what is the same in the parent workflow. Note that the child workflow inherits state A as is from the parent workflow.

FIG. 12B depicts before status 1210, which is identical to that of after status 1202. After status 1212 depicts addition of state D to the parent workflow, with transitions from state A and to state B. Normally, the child workflow would inherit state D, but this does not happen because the child workflow already has state C with transitions from state A and to its overridden state B. In after status 1212, the states and transitions of the parent workflow are shown with dashed lines to visually differentiate between what has changed from and what is the same in the parent workflow. Note that the child workflow inherits state A as is from the parent workflow.

FIG. 12C depicts before status 1220, which is identical to that of after status 1202. After status 1222 depicts replacement of state B with state D in the parent workflow (e.g., state B is removed and then state D is added). Since state B is removed from the parent, it is also removed from the child workflow despite the child workflow having overridden this state. The child workflow consists only of state A with a transition to state C. In after status 1222, the states and transitions of the parent workflow are shown with dashed lines to visually differentiate between what has changed from and what is the same in the parent workflow. Note that the child workflow inherits state A as is from the parent workflow.

### XI. Example Operations

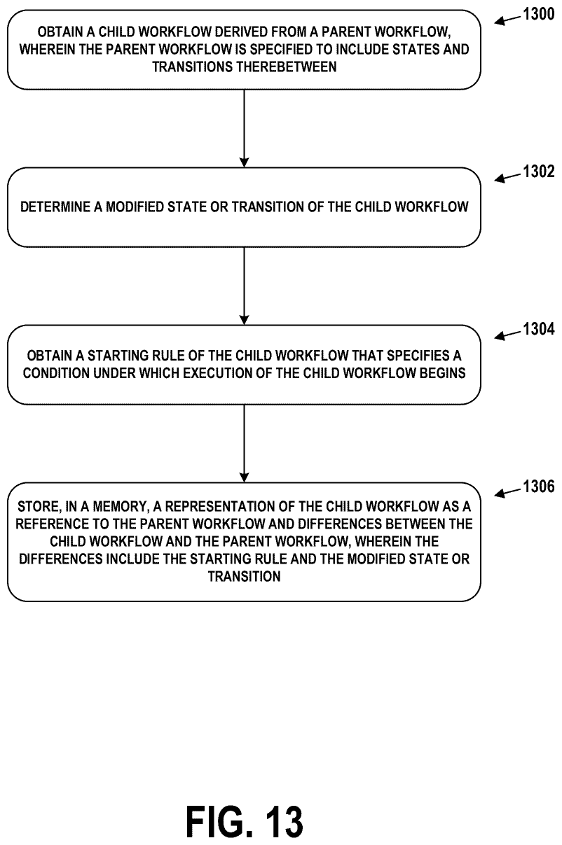

FIG. 13 is a flow chart illustrating an example embodiment. The process illustrated by FIG. 13 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 13 may be simplified by the removal of any one or more of the features shown therein. Further, these embodiments may be combined with features, aspects, and/or implementations of any of the previous figures or otherwise described herein.

Block 1300 may involve obtaining a child workflow derived from a parent workflow, wherein the parent workflow is specified to include states and transitions therebetween.

Block 1302 may involve determining a modified state or transition of the child workflow.

Block 1304 may involve obtaining a starting rule of the child workflow that specifies a condition under which execution of the child workflow begins.

Block 1306 may involve storing, in a memory, a representation of the child workflow as a reference to the parent workflow and differences between the child workflow and the parent workflow, wherein the differences include the starting rule and the modified state or transition. Block 1306, in particular, reflects a technical improvement, at least due to it requiring less memory than if all states, transitions, and other data from the parent workflow were copied into the child workflow. By referring to states that are common between the parent workflow and the child workflow, the memory representation of the child workflow is reduced accordingly. Further, the layering of the workflows in this fashion avoids implementation of a large, complex single workflow that would not be easily maintainable.

Some embodiments may further involve, based on the condition of the starting rule being met, executing the child workflow for a work item.

In some embodiments, obtaining the child workflow derived from the parent workflow comprises: generating a representation of the parent workflow for display on a graphic user interface; and receiving edits made by way of the graphical user interface, wherein the edits define the child workflow.

In some embodiments, the modified state or transition of the child workflow comprises a new state or transition that is not in the parent workflow being added to the child workflow or a state or transition of the parent workflow being removed from the child workflow.

In some embodiments, the modified state or transition of the child workflow comprises overriding a state of the parent workflow with new processing or conditions.

Some embodiments may further involve: obtaining a second child workflow derived from the parent workflow; determining a second modified state or transition of the second child workflow; obtaining a second starting rule of the second child workflow that specifies a second condition under which execution of the second child workflow begins; and storing, in the memory, a second representation of the second child workflow as a second reference to the parent workflow and differences between the second child workflow and the parent workflow, wherein the differences include the second starting rule and the second modified state or transition.

Some embodiments may further involve: obtaining a second child workflow derived from the child workflow; determining a second modified state or transition of the second child workflow; obtaining a second starting rule of the second child workflow that specifies a second condition under which execution of the second child workflow begins; and storing, in the memory, a second representation of the second child workflow as a second reference to the child workflow and differences between the second child workflow and the child workflow, wherein the differences include the second starting rule and the second modified state or transition.

In some embodiments, state modifications to the parent workflow are automatically inherited by the child workflow, with an exception when (i) the state modifications are not deletion of a state, and (ii) the state that has been overridden by the child workflow.

In some embodiments, state modifications to the parent workflow are automatically inherited by the child workflow, with an exception when the state modifications include addition of a state with identical transitions to a state that already has been added to the child workflow.

In some embodiments, state modifications to the child workflow do not change the parent workflow.

In some embodiments, a user that has permission to modify the parent workflow can also modify the child workflow, but a further user that has permission to modify the child workflow does not have permission to modify the parent workflow.

In some embodiments, execution of the parent workflow can be rewound to become execution of the child workflow, and wherein execution of the child workflow can be rewound to become execution of the parent workflow.

Some embodiments may further involve: generating a representation of a workflow for display on a graphic user interface, wherein the workflow is either the parent workflow or the child workflow; receiving edits made by way of the graphical user interface, wherein the edits delete a state from the workflow; and holding any previous or subsequent states to the state deleted from the workflow in position on the graphical user interface until editing concludes.

### XII. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
obtaining a child workflow derived from a parent workflow, wherein the parent workflow is specified to include states and transitions therebetween;
determining a modified state or transition of the child workflow;
obtaining a starting rule of the child workflow that specifies a condition under which execution of the child workflow begins; and
storing, in a memory, a representation of the child workflow as a reference to the parent workflow and differences between the child workflow and the parent workflow, wherein the differences include the starting rule and the modified state or transition.

2. The method of claim 1, further comprising:
based on the condition of the starting rule being met, executing the child workflow for a work item.

3. The method of claim 1, wherein obtaining the child workflow derived from the parent workflow comprises:
generating a representation of the parent workflow for display on a graphic user interface; and
receiving edits made by way of the graphical user interface, wherein the edits define the child workflow.

4. The method of claim 1, wherein the modified state or transition of the child workflow comprises a new state or transition that is not in the parent workflow being added to the child workflow or a state or transition of the parent workflow being removed from the child workflow.

5. The method of claim 1, wherein the modified state or transition of the child workflow comprises overriding a state of the parent workflow with new processing or conditions.

6. The method of claim 1, further comprising:
obtaining a second child workflow derived from the parent workflow;
determining a second modified state or transition of the second child workflow;
obtaining a second starting rule of the second child workflow that specifies a second condition under which execution of the second child workflow begins; and
storing, in the memory, a second representation of the second child workflow as a second reference to the parent workflow and differences between the second child workflow and the parent workflow, wherein the differences include the second starting rule and the second modified state or transition.

7. The method of claim 1, further comprising:
obtaining a second child workflow derived from the child workflow;
determining a second modified state or transition of the second child workflow;
obtaining a second starting rule of the second child workflow that specifies a second condition under which execution of the second child workflow begins; and
storing, in the memory, a second representation of the second child workflow as a second reference to the child workflow and differences between the second child workflow and the child workflow, wherein the differences include the second starting rule and the second modified state or transition.

8. The method of claim 1, wherein state modifications to the parent workflow are automatically inherited by the child workflow, with an exception when (i) the state modifications are not deletion of a state, and (ii) the state that has been overridden by the child workflow.

9. The method of claim 1, wherein state modifications to the parent workflow are automatically inherited by the child workflow, with an exception when the state modifications include addition of a state with identical transitions to a state that already has been added to the child workflow.

10. The method of claim 1, wherein state modifications to the child workflow do not change the parent workflow.

11. The method of claim 1, wherein a user that has permission to modify the parent workflow can also modify the child workflow, but a further user that has permission to modify the child workflow does not have permission to modify the parent workflow.

12. The method of claim 1, wherein execution of the parent workflow can be rewound to become execution of the child workflow, and wherein execution of the child workflow can be rewound to become execution of the parent workflow.

13. The method of claim 1, further comprising:
generating a representation of a workflow for display on a graphic user interface, wherein the workflow is either the parent workflow or the child workflow;
receiving edits made by way of the graphical user interface, wherein the edits delete a state from the workflow; and
holding any previous or subsequent states to the state deleted from the workflow in position on the graphical user interface until editing concludes.

14. A non-transitory computer-readable medium, having stored thereon program instructions that, upon execution by a computing system, cause the computing system to perform operations comprising:
obtaining a child workflow derived from a parent workflow, wherein the parent workflow is specified to include states and transitions therebetween;
determining a modified state or transition of the child workflow;
obtaining a starting rule of the child workflow that specifies a condition under which execution of the child workflow begins; and
storing, in a memory, a representation of the child workflow as a reference to the parent workflow and differences between the child workflow and the parent workflow, wherein the differences include the starting rule and the modified state or transition.

15. The non-transitory computer-readable medium of claim 14, the operations further comprising:
based on the condition of the starting rule being met, executing the child workflow for a work item.

16. The non-transitory computer-readable medium of claim 14, wherein obtaining the child workflow derived from the parent workflow comprises:
generating a representation of the parent workflow for display on a graphic user interface; and
receiving edits made by way of the graphical user interface, wherein the edits define the child workflow.

17. The non-transitory computer-readable medium of claim 14, wherein a user that has permission to modify the parent workflow can also modify the child workflow, but a further user that has permission to modify the child workflow does not have permission to modify the parent workflow.

18. The non-transitory computer-readable medium of claim 14, wherein execution of the parent workflow can be rewound to become execution of the child workflow, and wherein execution of the child workflow can be rewound to become execution of the parent workflow.

19. The non-transitory computer-readable medium of claim 14, the operations further comprising:
generating a representation of a workflow for display on a graphic user interface, wherein the workflow is either the parent workflow or the child workflow;
receiving edits made by way of the graphical user interface, wherein the edits delete a state from the workflow; and
holding any previous or subsequent states to the state deleted from the workflow in position on the graphical user interface until editing concludes.

20. A system comprising:
one or more processors; and
memory, containing program instructions that, upon execution by the one or more processors, cause the system to perform operations comprising:
obtaining a child workflow derived from a parent workflow, wherein the parent workflow is specified to include states and transitions therebetween;
determining a modified state or transition of the child workflow;
obtaining a starting rule of the child workflow that specifies a condition under which execution of the child workflow begins; and
storing, in a memory, a representation of the child workflow as a reference to the parent workflow and differences between the child workflow and the parent workflow, wherein the differences include the starting rule and the modified state or transition.
